(19) United States
(12) Patent Application Publication
(10) Pub. No.: US 2015/0130867 A1
(43) Pub. Date: May 14, 2015

(54) APPARATUS AND METHOD FOR CONTROLLING POWER

(71) Applicant: Samsung Electronics Co., Ltd., Gyeonggi-do (KR)

(72) Inventors: Dongyoul Park, Gyeonggi-do (KR); Jungtae Kwon, Gyeonggi-do (KR); Soohyung Kim, Gyeonggi-do (KR); Jaemyung Baek, Gyeonggi-do (KR); Jongkon Bae, Seoul (KR); Yongman Lee, Gyeonggi-do (KR)

(21) Appl. No.: 14/535,276

(22) Filed: Nov. 6, 2014

(30) Foreign Application Priority Data
Nov. 6, 2013 (KR) 10-2013-0134337

(51) Int. Cl. G09G 3/20; G09G 3/32

(52) U.S. Cl. CPC G09G 3/2003; G09G 3/3258; G09G 2330/028
USPC 345/694; 345/77

(57) ABSTRACT

An electronic device for adjusting voltages for each pixel includes an image processing unit to process a gray level corresponding to an image data, a gray data processing unit to determine voltages applied to each pixel of a display unit by using the gray level, and a power controller to control the voltage applied to each pixel of the display unit based on the determined voltage. Other embodiments including a method for adjusting voltages for each pixel are also disclosed.

### CROSS-REFERENCE TO RELATED APPLICATION AND CLAIM OF PRIORITY

The present application is related to and claims priority from and the benefit under 35 U.S.C. §119(a) of Korean Patent Application No. 10-2013-0134337, filed on Nov. 6, 2013, which is hereby incorporated by reference for all purposes as if fully set forth herein.

### TECHNICAL FIELD

The present disclosure relates to a method and apparatus for controlling a power or a voltage applied to each pixel of a display unit.

### BACKGROUND

An organic light emitting display device uses an Organic Light Emitting Diode, which utilizes a light emission phenomenon caused by an electric field. The organic light emitting display device is considered as a next-generation flat panel display due to its high contrast ratio and excellent view ability caused from a self-emission characteristic, a high luminance and a wide viewing angle, and a high speed response characteristics.

### SUMMARY

To address the above-discussed deficiencies, it is a primary object to provide an electronic device includes an image processing unit to process a gray level corresponding to an image data, a gray data processing unit to determine a voltage applied to each pixel of a display unit by using the gray level; and a power controller to control the voltage applied to each pixel of the display unit based on the determined voltage.

In accordance with another aspect of the present disclosure, an electronic device includes a power adjustment unit to adjust voltages according to a color layout of a display unit; and a power controller to control the voltages applied to each pixel of the display unit based on the adjusted voltage according to image data.

In accordance with another aspect of the present disclosure, a power control method includes: processing a gray level corresponding to an image data, determining voltages applied to each pixel of a display unit by using the gray level, and controlling the voltages applied to each pixel of the display unit based on the determined voltage.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A and 1B are block diagrams illustrating an electronic device according to an embodiment of the present disclosure;

FIG. 2 is a diagram illustrating an example of processing a gray level in an image processing unit according to an embodiment of the present disclosure;

FIGS. 3A and 3B are diagrams illustrating examples of controlling a voltage by using an automatic current limiter according to embodiments of the present disclosure;

FIGS. 4A and 4C are diagrams illustrating an example of a trend line indicating a correlation between a luminance and a voltage according to embodiments of the present disclosure;

FIGS. 5A and 5B are block diagrams illustrating an electronic device according to various embodiments of the present disclosure;

FIGS. 6A and 6B are block diagrams illustrating an electronic device according to various embodiments of the present disclosure;

FIG. 7 is a block diagram illustrating an electronic device according to various embodiments of the present disclosure;

FIG. 8 is a diagram illustrating an example of adjusting voltages according to an embodiment of the present disclosure;

FIGS. 9A to 9D are diagrams illustrating examples of adjusting voltages according to color filter patterns of a display unit according to embodiments of the present disclosure;

FIG. 10 is a diagram illustrating an example of adjusting voltages for each area of a display unit according to an embodiment of the present disclosure; and

FIG. 11 is a flowchart illustrating a power control method according to an embodiment of the present disclosure.

### DETAILED DESCRIPTION

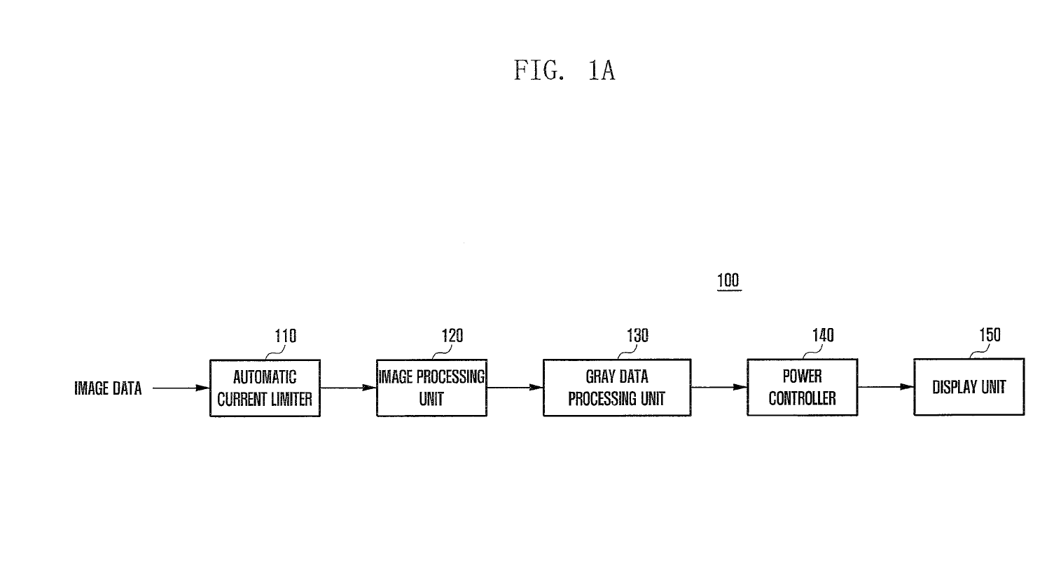

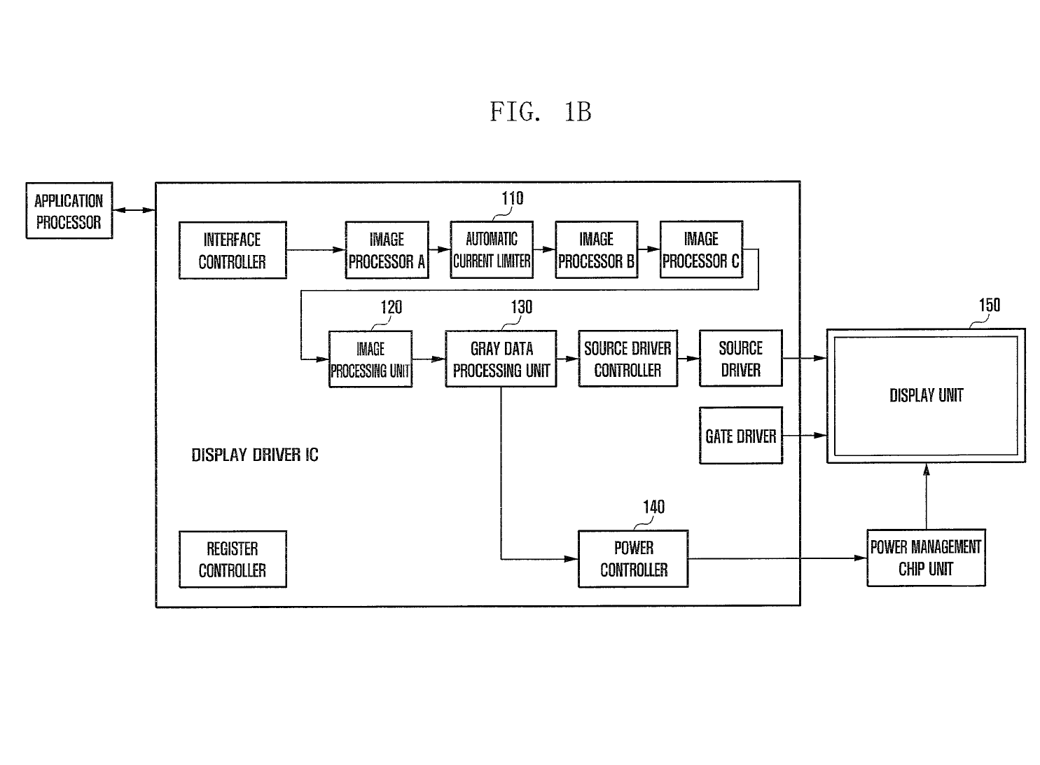

FIG. 1A through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged display technologies. Embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

An organic light emitting display device supplies a current corresponding to data voltage applied to a pixel circuit to an organic light emitting diode, thereby enabling the organic light emitting diode to emit a light with a luminance corresponding to the supplied current. In the meantime, the organic light emitting display device controls an output voltage for image data by using an output value outputted from an automatic current limiter (ACL). However, in this case, unnecessary voltage consumption is generated due to a difference between a gray level processed in the ACL and a gray level processed in an image processing unit.

According to an embodiment of the present disclosure, voltages applied to each pixel of a display unit can be determined by using a gray level processed through an image processing unit, so that a power consumed when displaying the image data can be reduced. Further, the gray level can be processed by using a pre-processing gray level obtained from the ACL so that a distortion of image data processed by the image processing unit can be prevented.

According to an embodiment of the present disclosure, a trend line indicating a correlation between a luminance value and a voltage value can be generated by using a gray level reflecting the pre-processing gray level obtained from the ACL, and voltages applied to each pixel of the display unit can be controlled based on the generated trend line, so that the voltage can be adjusted according to luminance value which has a high correlation with voltage. Further, two colors which have a high correlation of luminance value can be adjusted from among red, green and blue into a single voltage, so that a power required for the red, green blue can be adjusted respectively.

FIGS. 1A and 1B are block diagrams illustrating an electronic device with a power controller according to an embodiment of the present disclosure. Hereinafter, the arrow of “electronic device” in the FIGS. 1A, 1B, 5A, 5B, 6A, 6B and 7 indicates a display processing path.

Referring to FIGS. 1A and 1B, a 100 can include an automatic current limiter 110, an image processing unit 120, a gray data process unit 130, a power controller 140, and a display 150.

FIG. 1A is a schematic diagram illustrating the electronic device 100 schematically, and FIG. 1B is a diagram illustrating the electronic device 100 in detail.

The electronic device 100 of FIG. 1B can further include an interface controller, a register controller, a memory controller, an image processor A, an image processor B, an image processor C, a source driver controller, a source driver, a gate driver, a power management IC, as well as the automatic current limiter 110, the image processor 120, the gray data processing unit 130, the power controller 140, and the display unit 150. Such electronic device 100 can be implemented in a Display Driver IC.

The image processing unit 120 can process a gray level corresponding to an image data. The image processor 120 can serve to process the gray level of the image data appropriately in accordance with the characteristic of the display unit 150. According to an embodiment of the present disclosure, the image processing unit 120 can process the gray level corresponding to the image data according to a color filter pattern of the display unit 150. The color filter pattern means an arrangement in which colors such as red, green, blue, and white are differently disposed.

The color filter pattern can be a PenTile type pattern in which red, green, blue, and white are arranged, or can be a Bayer pattern in which red, green, blue, and green are arranged. The Bayer pattern is a pattern in which green, red and blue can be cross-arranged so that green can occupy 50% of a pattern and red and blue can occupy 25% of the pattern respectively. The image processing unit 120 can differently process each gray level corresponding to the image data according to the color filter pattern of the display unit 150.

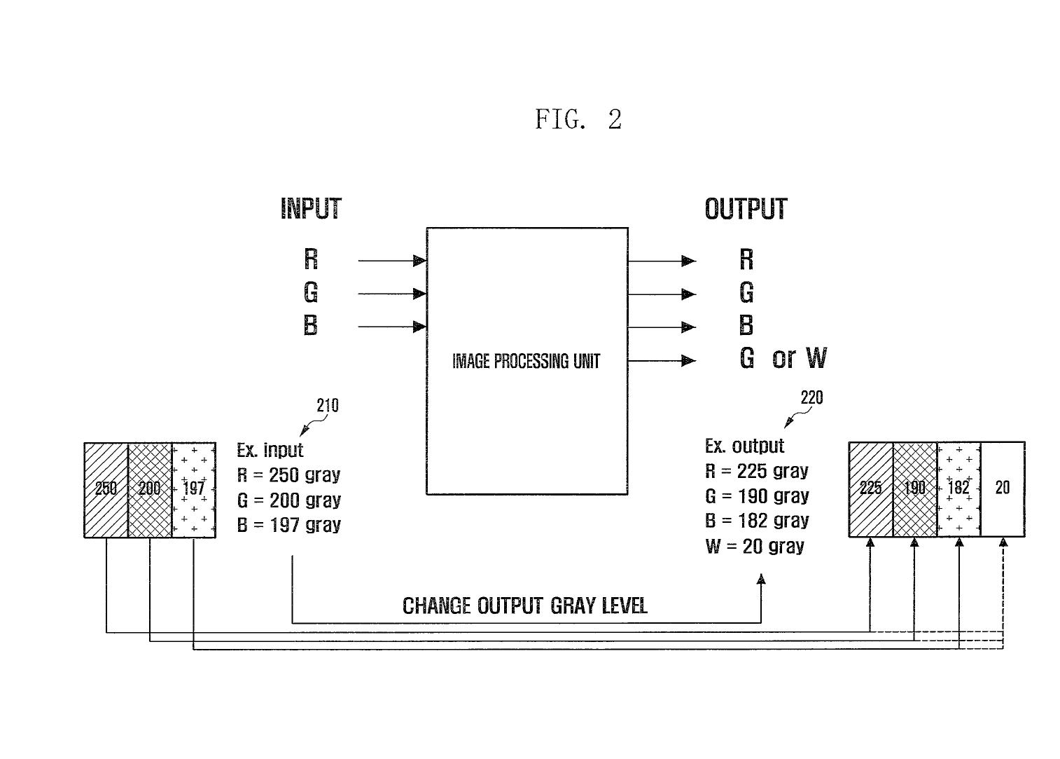

FIG. 2 is a diagram illustrating an example of processing a gray level in an image processing unit according to an embodiment of the present disclosure.

Referring to FIG. 2, in general, an image data inputted to the image processing unit 120 can be formed by combining three colors of red, green and blue. Referring to the reference numeral 210, a pre-processing gray level that has not been processed by the image processing unit 120 can have values of 250 for red, 200 for green, and 197 for blue.

In this case, the image processing unit 120 can process and output the pre-processing gray level 210 as red, green, blue and white according to the color filter pattern of the display unit to display the image data. Referring to the reference numeral 220, a gray level processed by the image processing unit 120 can have values of 225 for red, 190 for green, 182 for blue, and 20 for white. That is, the image processing unit 120 can process the gray level according to the color filter pattern of display unit 150.

In FIG. 2, the color filter pattern can be a PenTile type pattern consisting of red, green, blue and white colors. On the other hand, the image processing unit 120 can differently process the gray level dissimilarly to FIG. 2 with respect to the Bayer pattern which is different from the PenTile type pattern.

In the meantime, in the related art, the output voltage for the image data is controlled by using an output value of the automatic current limiter. However, an unnecessary output voltage is consumed due to a generation of a difference between the output value outputted from the automatic current limiter and the output value processed in the image processing unit.

In the present disclosure, the voltage is controlled by using the output value outputted from the image processing unit 120, not by using the output value outputted from the automatic current limiter 110, so that the use of an unnecessary voltage can be reduced. To this end, the image processing unit 120 can process the gray level by using the preprocessing gray level obtained from the automatic current limiter 110.

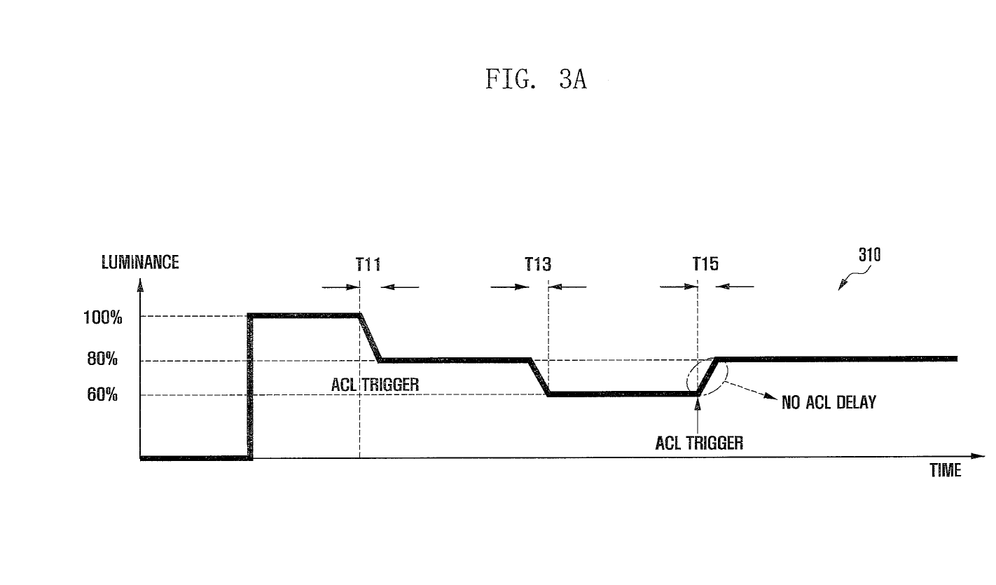

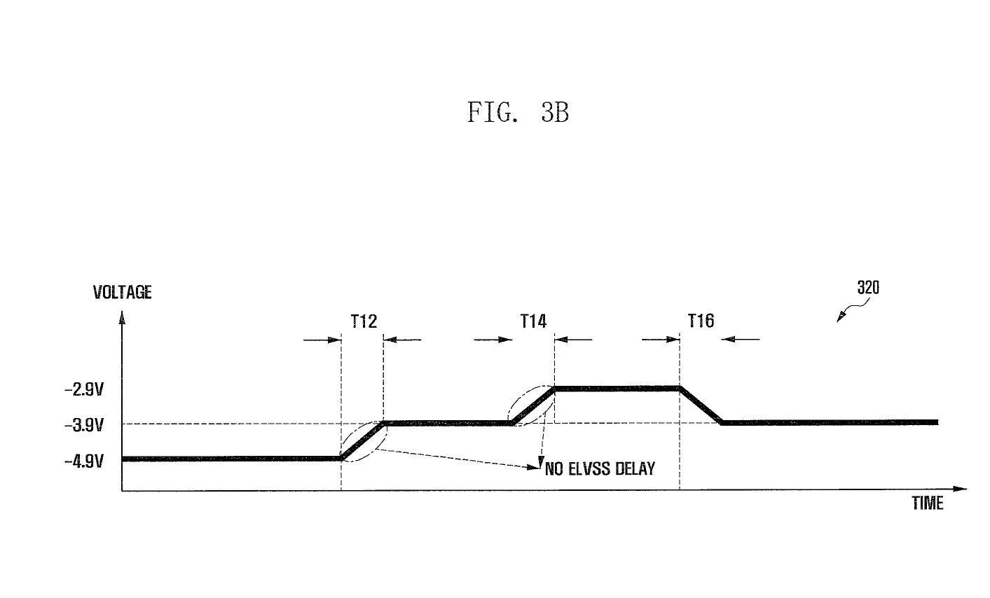

FIGS. 3A and 3B are diagrams illustrating examples of controlling a voltage by using an automatic current limiter according to an embodiment of the present disclosure. Referring to FIG. 3, generally, one of factors which cause a consumption of a large amount of voltage is brightness. Luminance can be a unit indicating a degree of brightness with a numerical value. The automatic current limiter 110 (ACL) can reduce a power consumption by lowering the gray level when displaying image data close to white. A first graph 310 in FIG. 3A can indicate a luminance value according to a time, and a second graph 320 in FIG. 3 can indicate a voltage value according to a time. That is, the voltage values and the luminance values can be inversely proportional to each other, and it can be known that the luminance values and the voltage value can be changed when triggering the automatic current limiter.

Thus, the image processing unit 120 can process the gray level by using the pre-processing gray level obtained from the automatic current limiter 120 such that the distortion can be prevented.

The gray data processing unit 130 can determine voltage applied to each pixel of display unit by using the gray level processed by the image processing unit 120. According to an embodiment of the present disclosure, the gray data processing unit 130 can determine voltage applied to each pixel of display unit by using the gray level having a maximum value. The gray data processing unit 130 can determine voltage based on the maximum value of the gray level among the gray level processed in the image processing unit 120.

According to various embodiments of the present disclosure, the gray data processing unit 130 can determine voltage applied to each pixel of display unit by using the gray level having an average value. The gray data processing unit 130 can determine a voltage based on the average value of the gray level processed in the image processing unit 120.

According to various embodiments of the present disclosure, the gray data processing unit 130 can generate a trend line indicating a correlation between a luminance and a voltage by using the gray level reflecting the pre-processing gray level, and can determine voltages applied to each pixel of display unit based on the generated trend line.

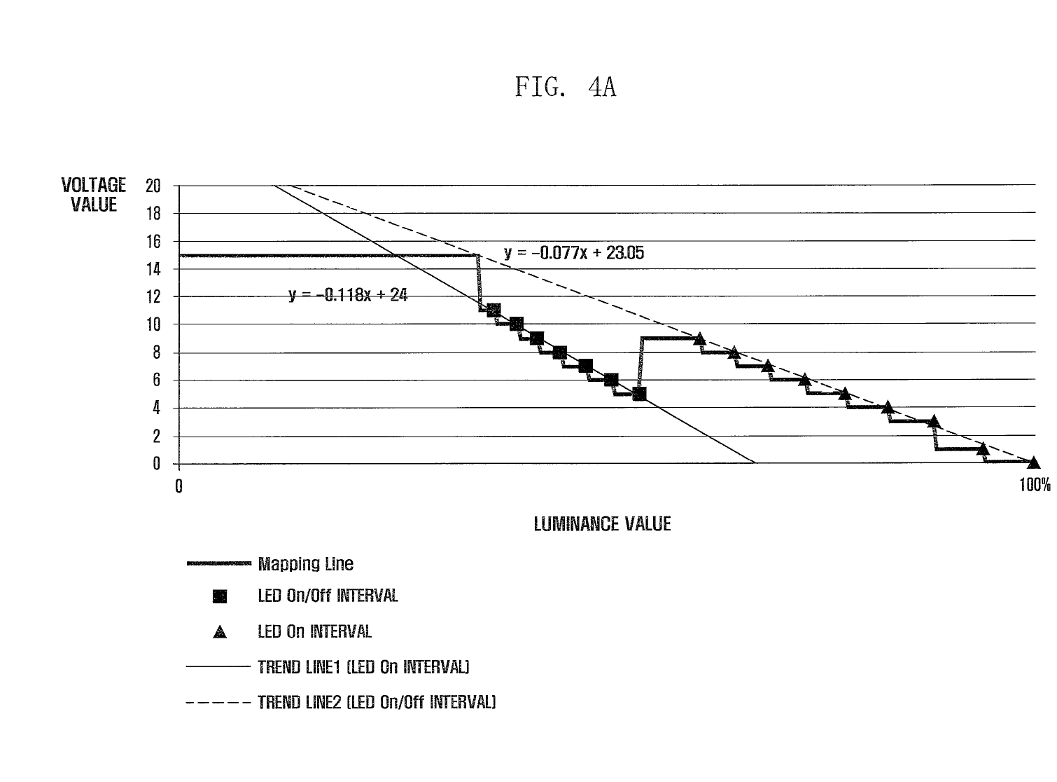

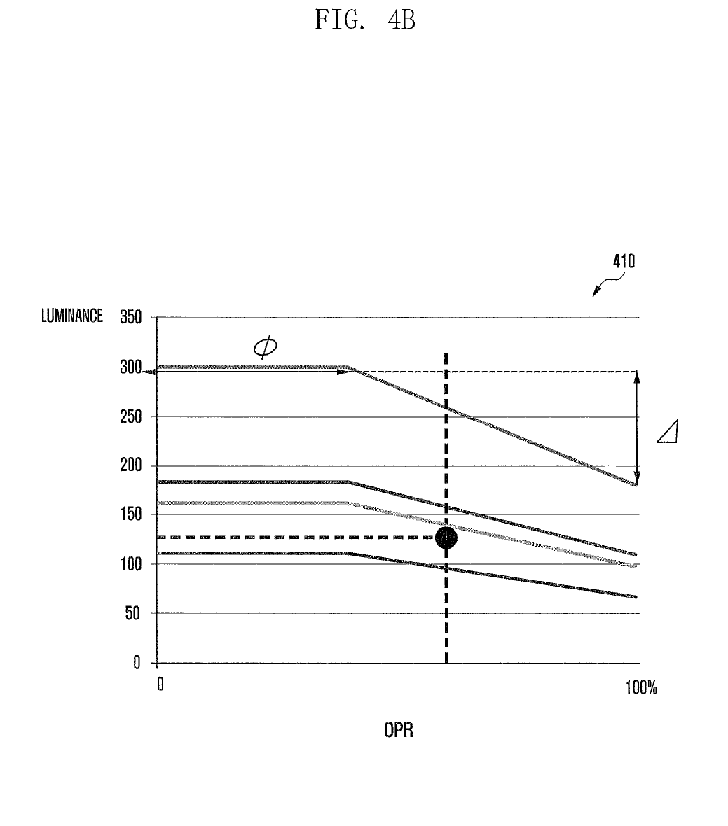

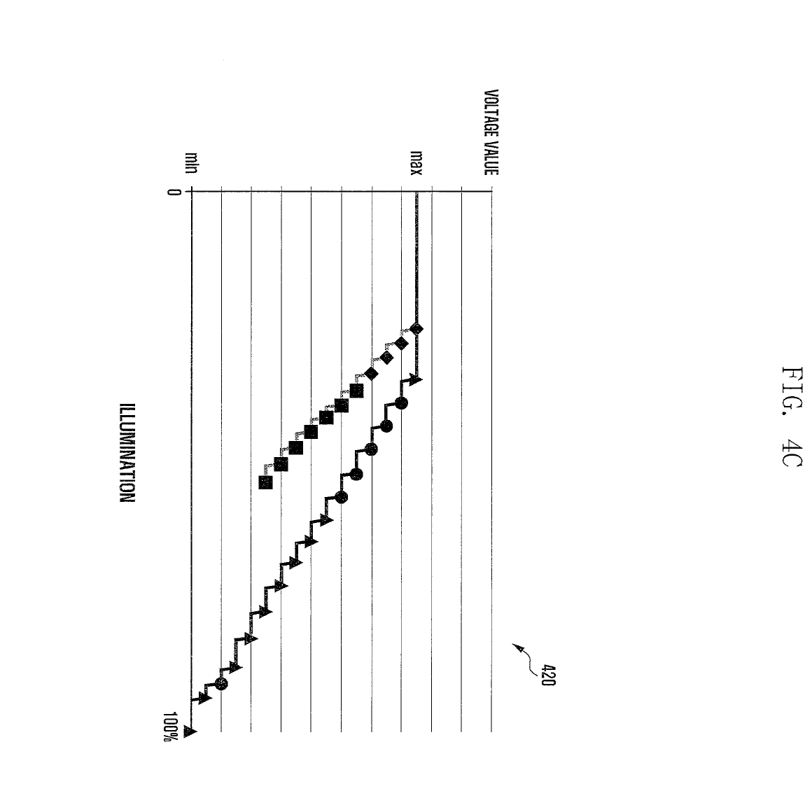

FIGS. 4A and 4B are diagrams illustrating an example of a trend line indicating a correlation between a luminance and a voltage according to an embodiment of the present disclosure.

Referring to FIG. 4A, the gray data processing unit 130 can adjust a voltage value by dividing an interval that drives an LED by turning on/off the LED according to luminance value. For example, the gray data processing unit 130 can generate a trend line 1 that reduces a voltage value by turning the LED on at luminance value 105 according to Equation 1:

y=−0.118x+24. (Equation. 1)

The trend line 1 is indicated by a solid line in FIG. 4A. However, since a drive system of the LED is changed at luminance value 161, the gray data processing unit 130 can generate a trend line 2 according to Equation 2:

y=−0.077x+23.05. (Equation 2)

The trend line 2 is indicated by a dotted line in FIG. 4A. That is, as the drive system of the LED is changed, the equation which generates the trend line can also be changed.

Referring to FIG. 4B, when image data is inputted, the gray data processing unit 130 can calculate a luminance value as shown in reference numeral 410 based on a brightness ratio (On Pixel Ratio; OPR) within the image data calculated in the automatic current limiter 110 and a luminance value set by a user.

$$y = \{ \begin{matrix}A ( 1 - ( \frac{Δ}{255 ( 1 - φ )} ) ( x - 255 φ ) ) & if x > 255 φ \\ A & esle\end{matrix} \qquad ( Equation 3 )$$

In Equation 3, y is a calculated luminance value, A is a reference setting value, x is a brightness ratio (OPR). At this time, A can be set based on a change of luminance value according to the brightness ratio (OPR) at the time of continuously turning the LED on.

In this case, the gray data processing unit 130 can determine an optimal voltage from the calculated luminance value y and the reference setting value A based on the trend line (noted by the reference numeral 420) indicating a correlation between the luminance and the voltage.

The power controller 140 can control voltages applied to each pixel of the display unit based on the determined voltage. According to an embodiment of the present disclosure, the power controller 140 can control an ELVSS voltage (the second voltage) applied to each pixel of AMOLED display.

The power controller 140 can control the voltage applied to each pixel of the display unit through the Power Management IC. The Power Management IC can include a state machine unit (not shown) to control at least one frame included in the image data in the order of voltage control. According to an embodiment of the present disclosure, the state machine unit can divide the image data into a plurality of areas, and can control in the order of the voltage control of the divided area.

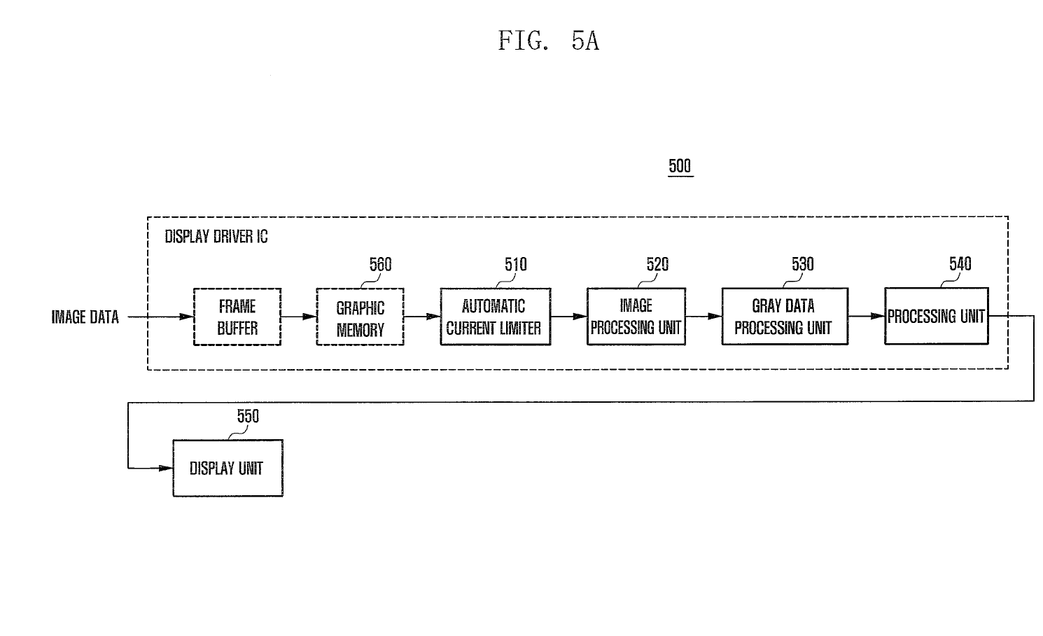

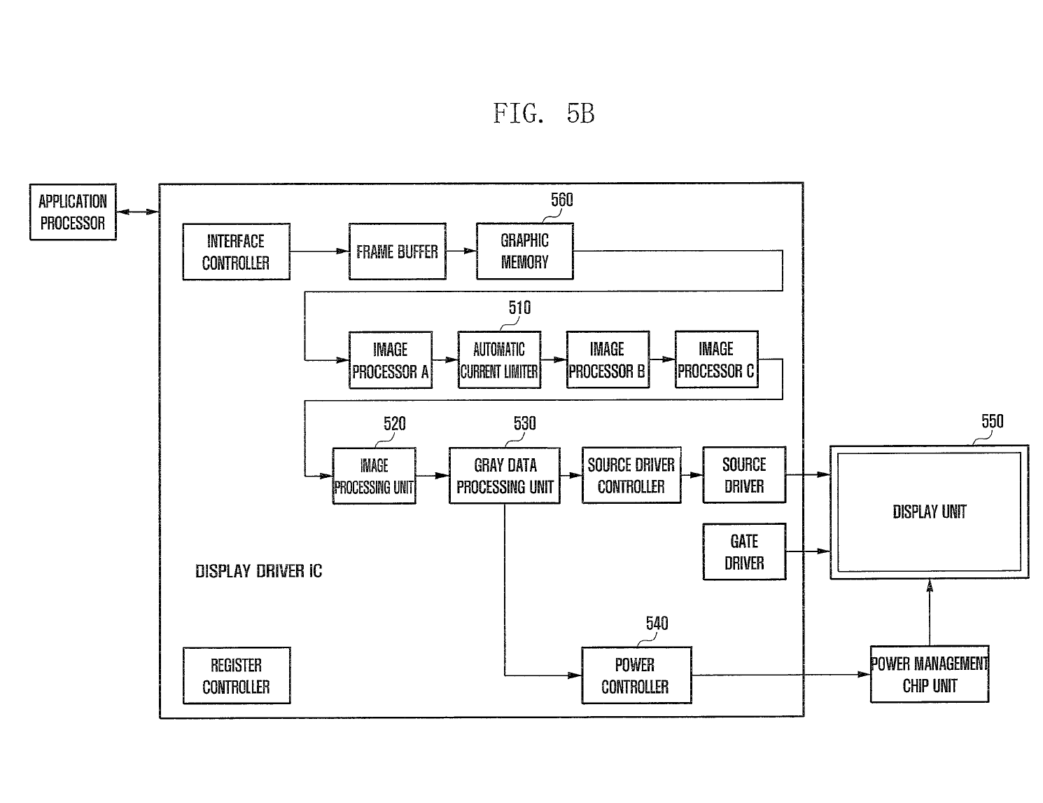

Hereinafter, FIGS. 5A, 5B, 6A, 6B, and 7 illustrate various embodiments of the electronic device described in FIGS. 1A and 1B. Since the elements included in the electronic device of FIGS. 5A, 5B, 6A, 6B, and 7 are identical with the elements having the same name included in the electronic device described in FIGS. 1A and 1B, the detailed description on the elements are omitted.

FIGS. 5A and 5B are block diagrams illustrating an electronic device according to various embodiments of the present disclosure.

Referring to FIG. 5A, an electronic device 500 can include an automatic current limiter 510, an image processing unit 520, a gray data processing unit 530, a power (voltage) controller 540, and a display unit 550, and can further include a graphic memory 560 previously operating to the automatic current limiter.

The electronic device of FIG. 5B can include the automatic current limiter 510, the image processing unit 520, the gray data processing unit 530, the power controller 540, the display unit 550, and the graphic memory 560, and can further include an interface controller, a register controller, a memory controller, an image processor A, an image processor B, an image processor C, a source driver controller, a source driver, a gate driver, and a power management IC.

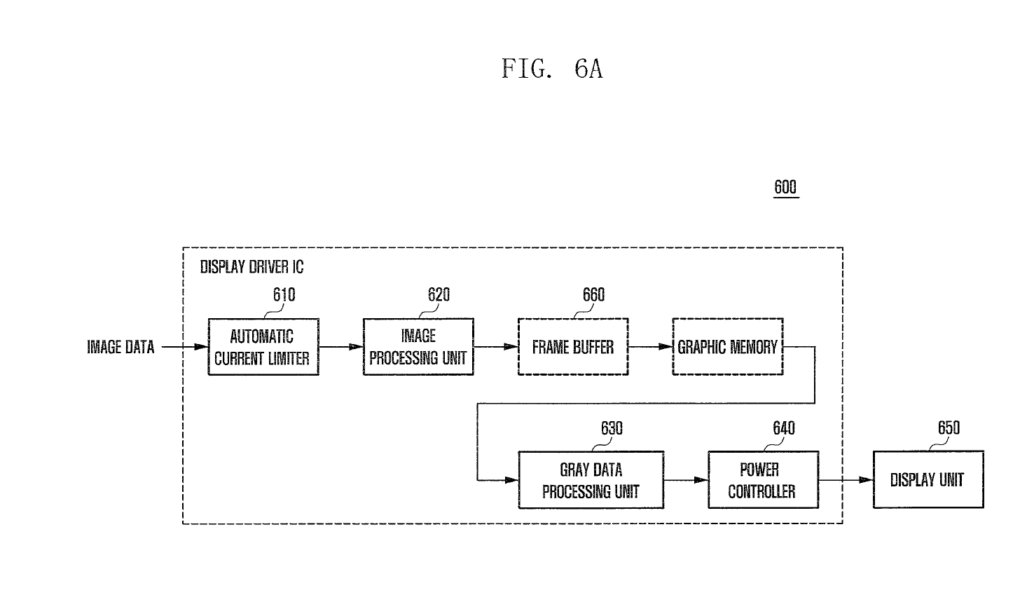

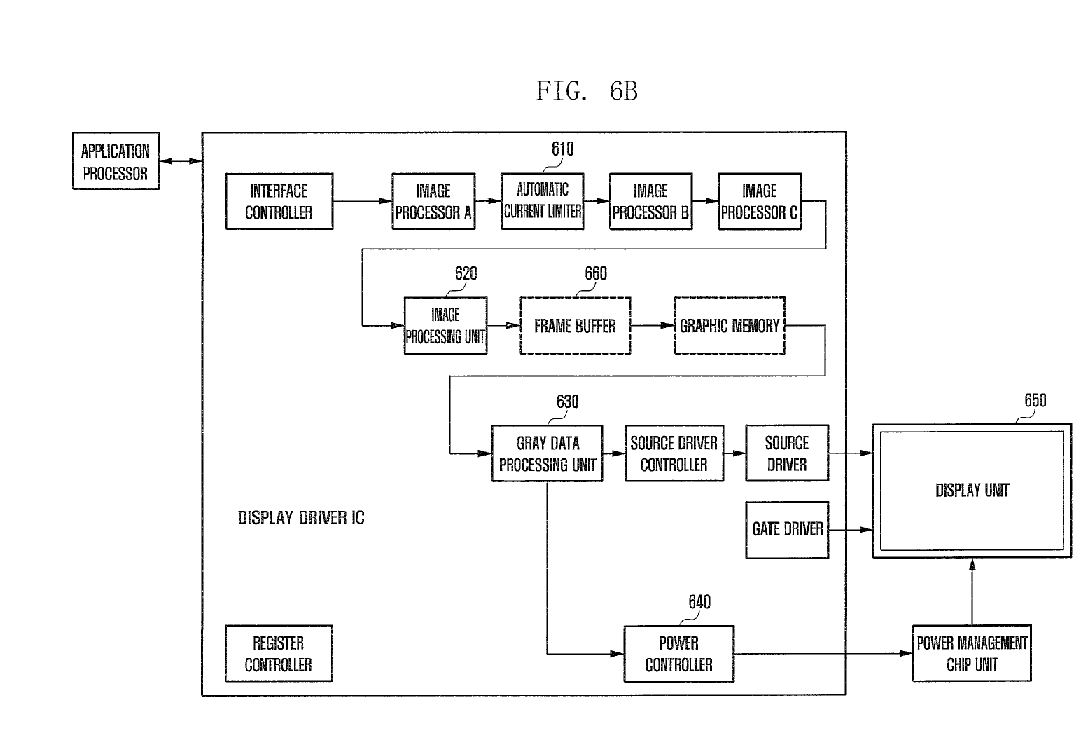

FIGS. 6A and 6B are block diagrams illustrating an electronic device according to various embodiments of the present disclosure.

Referring to FIG. 6A, an electronic device 600 can include an automatic current limiter 610, an image processing unit 620, a gray data processing unit 630, a power controller 640, and a display unit 650, and can further include a frame buffer 660 storing a gray level processed in the image processing unit 620. The gray data processing unit 630 can determine the voltage applied to each pixel of the display unit 650 by using the stored gray-level.

The electronic device of FIG. 6B can include the automatic current limiter 610, the image processing unit 620, the gray data processing unit 630, the power controller 640, the display unit 650, and the frame buffer 660, and can further include an interface controller, a register controller, a memory controller, an image processor A, an image processor B, an image processor C, a source driver controller, a source driver, a gate driver, and a power management IC.

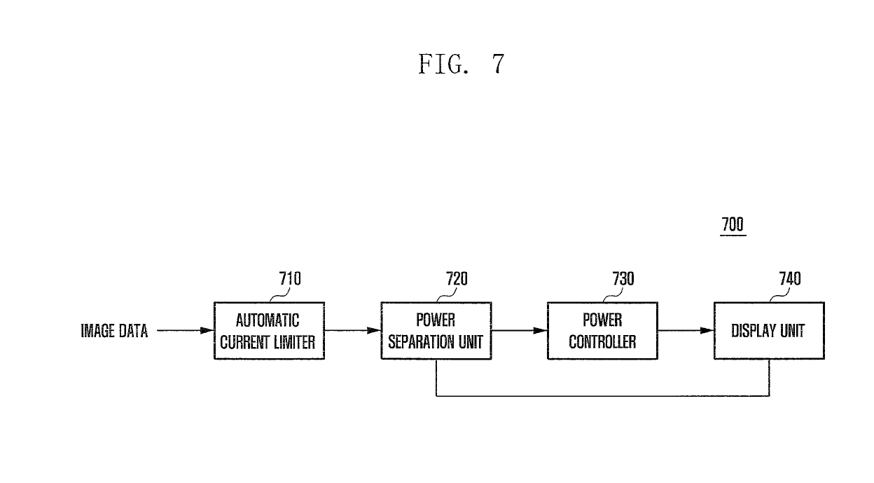

FIG. 7 is a block diagram illustrating an electronic device according to various embodiments of the present disclosure.

Referring to FIG. 7, an electronic device 700 can include an automatic current limiter 710, a power (voltage) adjustment unit 720, a power (voltage) controller 730, and a display unit 740.

The power adjustment unit 720 can adjust voltages according to a color layout of the display unit 740. The power adjustment unit 720 can adjust the voltage into three voltages for red, green and blue respectively. According to various embodiments of the present disclosure, the power adjustment unit 720 can adjust at least two of red, green, and blue into a single voltage.

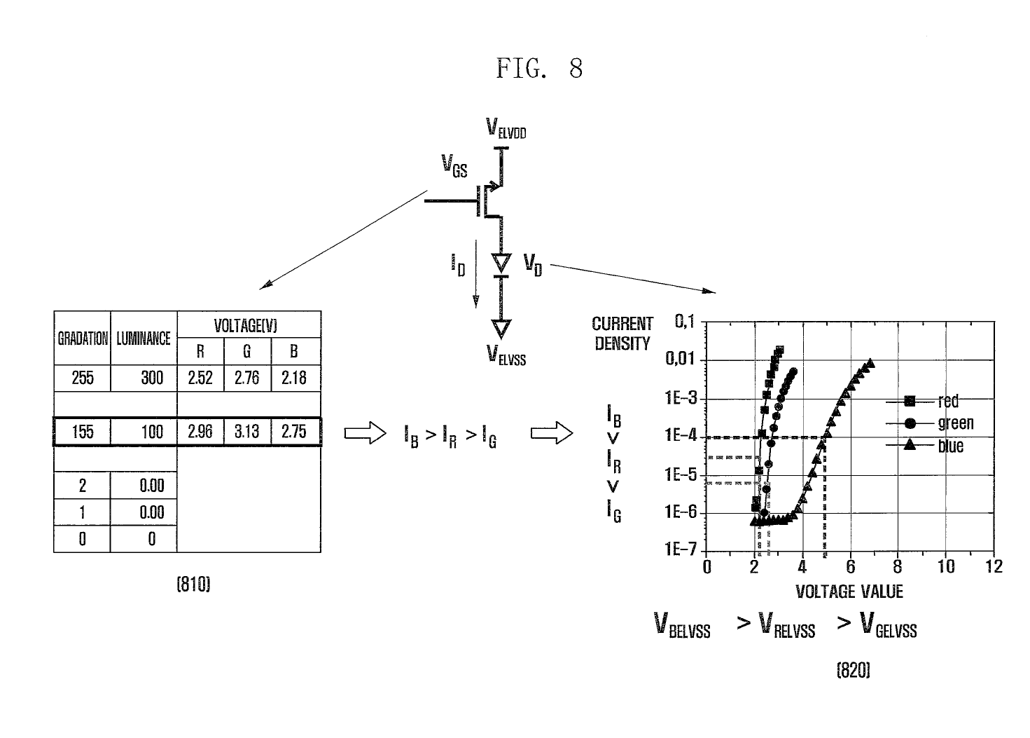

FIG. 8 is a diagram illustrating an example of adjusting voltages according to an embodiment of the present disclosure.

Referring to a first graph shown in reference numeral 810 of FIG. 8, voltages for colors of red, green and blue according to luminance are different from each other. That is, at luminance 100, red has a voltage value 2.96 which is similar to the voltage value of blue 2.75, whereas green has a voltage value 3.13 which is higher compared to red and blue. The second graph shown in the reference numeral 820 indicates a current density according to a voltage value. Thus, the power adjustment unit 720 can adjust red and blue which have a similar voltage value into a single voltage. That is, the power adjustment unit 720 may not adjust red, blue, and green into three voltages respectively, but can adjust red and blue into a single voltage while adjusting voltages for green into another voltage, so that voltages for red, blue, and green can be adjusted into two voltages. FIG. 8 illustrates that red and blue are adjusted into a single voltage, but the power adjustment unit 720 can adjust red and blue into a single voltage, or adjust green and blue into a single voltage according to image data.

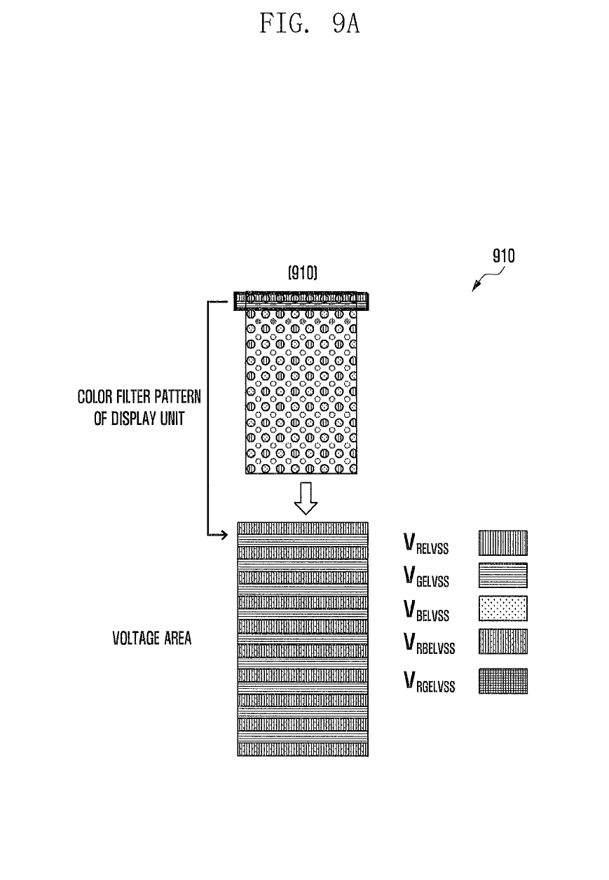

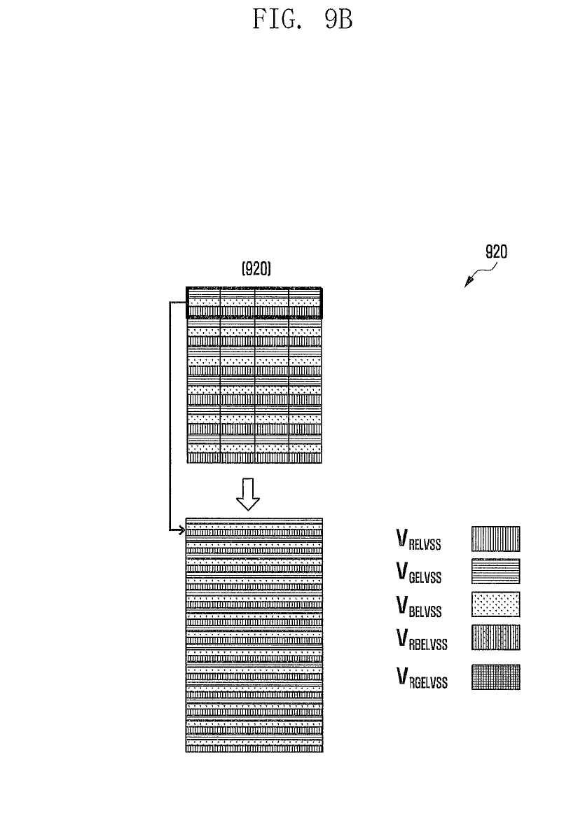

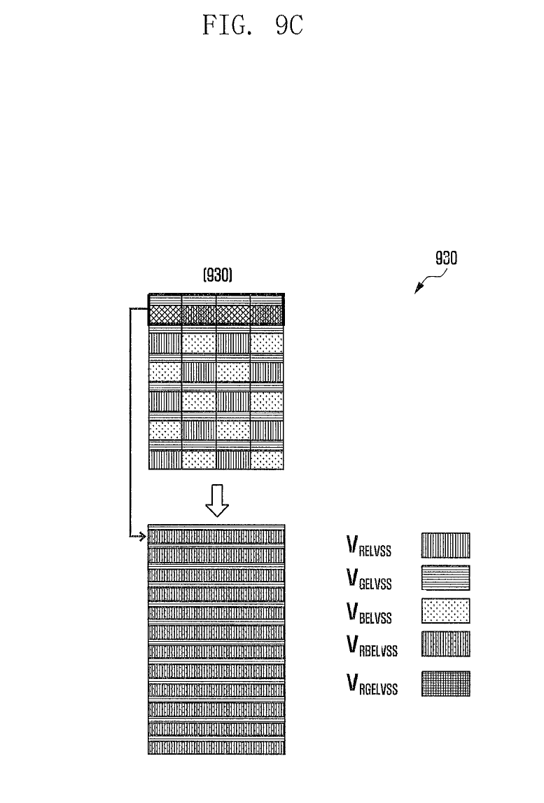

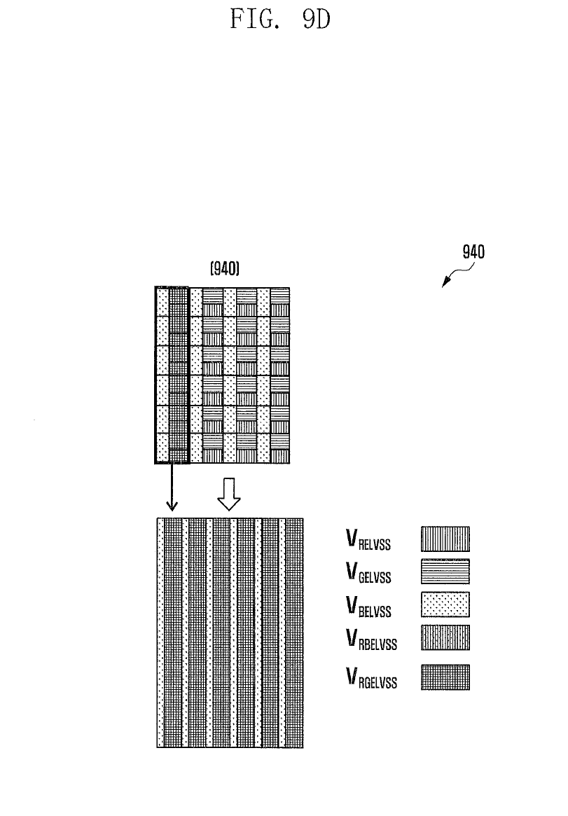

FIGS. 9A to 9D are diagrams illustrating examples of adjusting voltages according to a color filter pattern of a display unit according to embodiments of the present disclosure.

Referring to FIGS. 9A to 9D, a color layout of the display unit 740 can be any one of a dot type shown in reference numeral 910, a stripe type shown in reference numeral 920, a horizontal matrix type shown in reference numeral 930, and a vertical matrix type shown in reference numeral 940. The dot type 910 is a color layout in which red, green, and blue are arranged in a form of dot. The stripe type 920 is a color layout in which red (V_{RELVSS}), green (V_{BELVSS}), and blue (V_{BELVSS}) are arranged in a form of stripe. The horizontal matrix type 930 is a color layout in which green (V_{BELVSS}) is arranged in a form of stripe, and red (V_{RELVSS}) and blue (V_{BELVSS}) are cross-arranged. The vertical matrix type 940 is a color layout in which red (V_{RELVSS}) and green (V_{BELVSS}) are arranged in a form of horizontal stripe, and blue (V_{BELVSS}) is arranged in a form of vertical stripe. According to various embodiments of the present disclosure, the power adjustment unit 720 can adjust red and blue into a single voltage (V_{RBELVSS}) according to color layout, can adjust red and green into a single voltage (V_{RGELVSS}), or can adjust green and blue into a single voltage (V_{GBELVSS}). Thus, the power adjustment unit 720 can adjust three voltages for each of three colors into two voltages, such that voltage consumption can be reduced.

According to various embodiments of the present disclosure, the power adjustment unit 720 can adjust the display unit 740 into a plurality of areas, and can adjust voltages for each adjusted area.

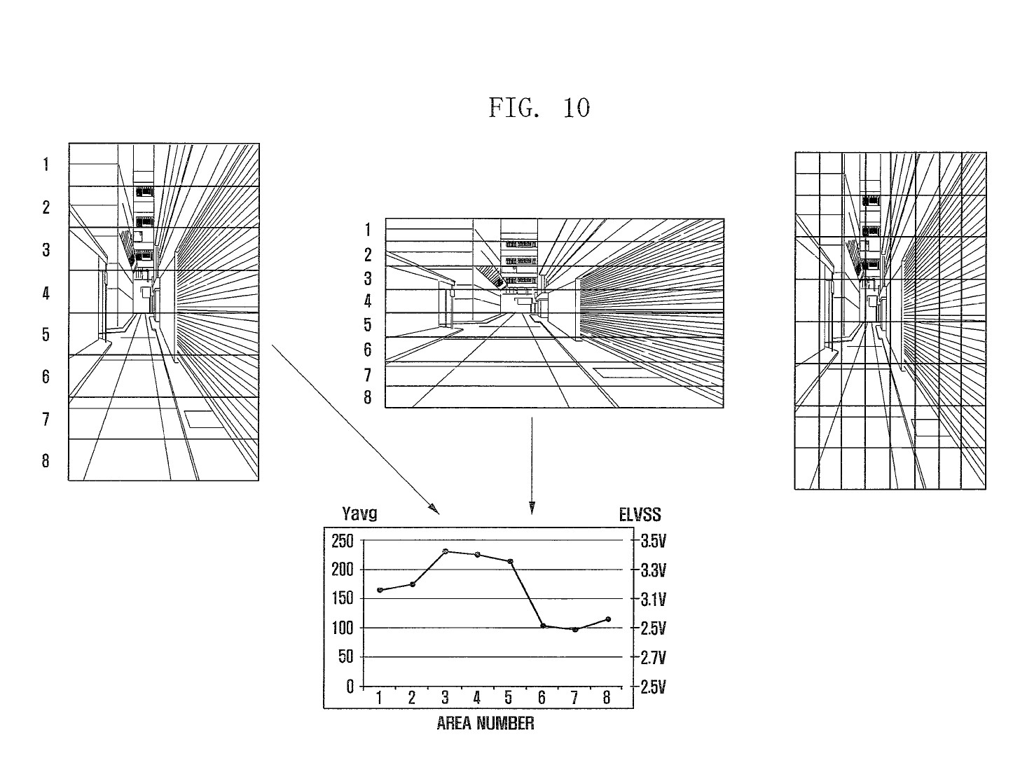

FIG. 10 is a diagram illustrating an example of adjusting voltages for each area of a display unit according to an embodiment of the present disclosure.

Referring to FIG. 10, the power adjustment unit 720 can adjust an area of display unit for displaying an image data into eight areas, and can adjust voltages for each adjusted area. That is, the power adjustment unit 720 can differently set voltages value for each area, thereby reducing the voltage consumption. Similarly, the power adjustment unit 720 can adjust the image data into a plurality of areas, and can determine voltages for each separated area.

The power controller 730 can control a voltage applied to each pixel of the display unit based on the separated voltage according to image data.

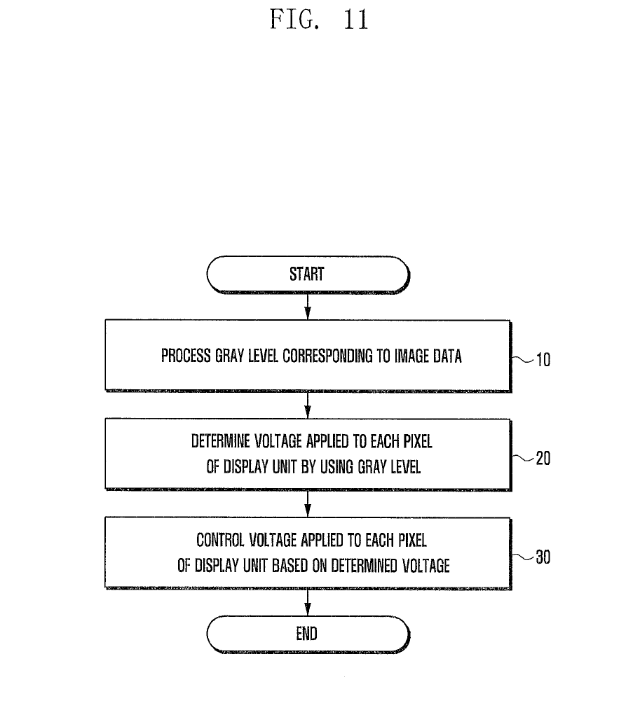

FIG. 11 is a flowchart illustrating a power control method according to an embodiment of the present disclosure. The power control method of FIG. 11 can be performed by the electronic device of FIG. 1.

Referring to FIG. 11, at operation 10, the electronic device can process a gray level corresponding to an image data. An image processing unit of the electronic device can process a gray level corresponding to the image data according to a color filter pattern of the display unit. At this time, the image processing unit can process the gray level by using a pre-processing gray level that the image data obtained through an automatic current limiter.

At operation 20, the electronic device can determine voltages applied to each pixel of display unit by using the gray level. According to an embodiment of the present disclosure, a gray data processing unit of the electronic device can determine the voltage applied to each pixel of display unit by using a maximum value of the processed gray level, or a mean value of the gray level. According to various embodiments of the present disclosure, the electronic device can generate a trend line indicating a correlation between a luminance and a voltage by using a gray level that reflects the pre-processing gray level, and can determine the voltage applied to each pixel of display unit based on the generated trend line.

According to various embodiments of the present disclosure, the power adjustment unit of the electronic device can adjust voltages according to a layout of the display unit. For example, the power adjustment unit can adjust at least two of red, green and blue into a single voltage. That is, the power adjustment unit can adjust two colors having a similar voltage value into a single voltage. For example, the power adjustment unit can adjust red and blue into a single voltage, can adjust red and green into a single voltage, or can adjust green and blue into a single voltage. Accordingly, the power adjustment unit may not adjust red, blue, and green into three voltages, but can adjust into two voltages, such that the voltage consumption can be reduced.

According to various embodiments of the present disclosure, the power adjustment unit can adjust the display unit into a plurality of areas, and can determine voltages for each adjusted area. Alternatively, the power adjustment unit can adjust the image data into a plurality of areas, and can determine voltages for each adjusted area.

At operation 30, the electronic device can control the voltage applied to each pixel of display unit based on the determined voltage. The power controller of the electronic device can control the voltage applied to each pixel of display unit by using a power management (or IC) unit. The power management unit can include a state machine unit to control at least one frame included in the image data in the order of voltage control.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A electronic device comprising:
an image processing unit configured to process a gray level corresponding to an image data;
a gray data processing unit configured to determine voltages to be applied to each pixel of a display, based on the gray level; and
a power controller configured to control each voltage applied to each pixel of the display unit based on the determined voltage.

2. The electronic device of claim 1, wherein the image processing unit is configured to process the gray level corresponding to the image data according to a color filter pattern of the display.

3. The electronic device of claim 2, wherein the color filter pattern of the display unit comprises either a PenTile type pattern comprising red, green, blue, and white, or a Bayer pattern comprising red, green, blue, and green.

4. The electronic device of claim 1, wherein the image processing unit is configured to process the gray level by using a preprocessing gray level obtained from an automatic current limiter (ACL).

5. The electronic device of claim 4, wherein the gray data processing unit is configure d to generate a trend line indicating a correlation between a luminance and a voltage by using a gray level reflecting the preprocessing gray level, and determine the voltage applied to each pixel of the display, based on the generated trend line.

6. The electronic device of claim 1, wherein the gray data processing unit is configured to determine the voltage applied to each pixel of the display by using a gray level having a maximum value.

7. The electronic device of claim 1, wherein the gray data processing unit is configured to determine the voltage applied to each pixel of the display by using a gray level having a mean value.

8. The electronic device of claim 1, further comprising a frame buffer to store the processed gray level, wherein the gray data processing unit is configured to determine the voltage applied to each pixel of the display unit by using a gray level stored in the frame buffer.

9. The electronic device of claim 1, wherein the power controller is configured to control an ELVSS voltage applied to each pixel of AMOLED display, based on the determined voltage.

10. The electronic device of claim 1, wherein the power controller is configured to control the voltage applied to each pixel of the display unit through a power management unit.

11. The electronic device of claim 10, wherein the power management unit comprises a state machine unit to control at least one frame included in the image data in order of voltage control.

12. The electronic device of claim 10, wherein the power management unit is configured to divide the image data into a plurality of areas to control in order of voltage control of divided area.

13. A electronic device comprising:
a voltage adjustment unit configured to adjust a voltage according to a color layout of a display; and
a voltage controller configured to control voltages applied to each pixel of the display unit based on the adjusted voltage according to image data.

14. The electronic device of claim 13, wherein the voltage adjustment unit is configured to adjust at least two of red, green, and blue which are a color filter pattern of the display unit into a single voltage.

15. The electronic device of claim 13, wherein the voltage adjustment unit is configured to adjust the display unit into a plurality of areas, and adjust a voltage for each adjusted area.

16. A method comprising:
processing a gray level corresponding to an image data;
determining voltages to be applied to each pixel of a display by using the gray level; and
controlling the voltage applied to each pixel of the display based on the determined voltage.

17. The method of claim 16, wherein processing the gray level comprises processing a gray level corresponding to the image data according to a color filter pattern of the display.

18. The method of claim 16, wherein processing the gray level comprises processing a gray level by using a preprocessing gray level obtained from an automatic current limiter.

19. The method of claim 18, wherein determining the voltage comprises:
generating a trend line indicating a correlation between a luminance and a voltage by using a gray level reflecting the preprocessing gray level; and
determining the voltage to be applied to each pixel of the display based on the generated trend line.

20. The method of claim 16, wherein determining the voltage comprises at least one of:
determining the voltage to be applied to each pixel of the display by using a gray level having a maximum value or a mean value;
adjusting a voltage according to a color layout of the display;
adjusting the display unit into a plurality of areas, and determining voltages for each adjusted area;
adjusting the image data into a plurality of areas, and determining voltages for each adjusted area.
